(19) United States
(12) Patent Application Publication
(10) Pub. No.: US 2008/0236346 A1
(43) Pub. Date: Oct. 2, 2008

(54) UNIVERSAL PRIMARY LOCKING TOOL

(75) Inventors: Brian Klett, Hubertus, WI (US); Mark Schaefer, Racine, WI (US); Michael Duley, Slinger, WI (US)

Correspondence Address: MICHAEL BEST & FRIEDRICH LLP, 100 E WISCONSIN AVENUE, Suite 3300, MILWAUKEE, WI, 53202, US

(73) Assignee: HARLEY-DAVIDSON MOTOR COMPANY GROUP, INC., Milwaukee, WI (US)

(21) Appl. No.: 11/694,127

(22) Filed: Mar. 30, 2007

(51) Int. Cl. B25B 27/00

(52) U.S. Cl. 81/488; 29/281.5

(57) ABSTRACT

A primary locking tool for use with first and second primary drive assemblies. The first primary drive assembly includes a first drive sprocket and a first input sprocket a first distance from one another. The second primary drive assembly includes a second drive sprocket and a second input sprocket a second distance from one another. The second distance is greater than the first distance. The primary locking tool includes a first side portion having a drive jaw configured to engage the first and second drive sprockets. A second side portion includes an input jaw configured to engage the first and second input sprockets. The first and second side portions are coupled together for movement between a retracted position and an extended position that engage and resist rotation of the first drive sprocket and first input sprocket and the second drive sprocket and second input sprocket, respectively.

### BACKGROUND

The present invention relates to motorcycle engine-transmission assemblies having a primary drive between the engine and the transmission. More specifically, the present invention relates to primary locking tools used during assembly of the primary drive.

Some motorcycles include engine-transmission assemblies that include primary drives that transfer power from a crankshaft drive sprocket to a transmission shaft input sprocket. Different primary drive assemblies have different distances between the crankshaft drive sprocket and the transmission shaft input sprocket. In the past, different size tools were required to inhibit rotation of the shafts while a bolt or nut is tightened on each to fixedly attach components onto these shafts.

### SUMMARY

The present invention provides a primary locking tool for use with first and second primary drive assemblies. The first primary drive assembly includes a first drive sprocket and a first input sprocket a first distance from the first drive sprocket. The second primary drive assembly includes a second drive sprocket and a second input sprocket a second distance from the second drive sprocket. The second distance is greater than the first distance. The primary locking tool includes a first side portion, having a drive jaw configured to engage the first and second drive sprockets, and a second side portion, having an input jaw configured to engage the first and second input sprockets. The first and second side portions are coupled together for movement relative to each other between a retracted position, that engages and resists rotation of the first drive sprocket and the first input sprocket, and an extended position, that engages and resists rotation of the second drive sprocket and the second input sprocket.

The present invention provides a primary locking tool for use with first and second primary drive assemblies. The first primary drive assembly includes a first drive sprocket and a first input sprocket a first distance from the first drive sprocket. The second primary drive assembly includes a second drive sprocket and a second input sprocket a second distance from the second input sprocket. The second distance is greater than the first distance. The primary locking tool includes a first side portion, including a drive jaw configured to engage the first and second drive sprockets, a second side portion, including an input jaw configured to engage the first and second input sprockets, and a locking mechanism. The second side portion is coupled to the first side portion to allow for adjustment between at least first and second positions. The first and second side portions are disposed a further distance apart from each other in the second position than the first position. The locking mechanism engages, to lock the second side portion in one of the first and second position, and disengages, to allow adjustment of the second side portion between the first and second positions.

The present invention provides a method of assembling primary drive assemblies of engine-transmission assemblies. The method includes providing a first primary drive assembly including a first drive sprocket and a first input sprocket. The first drive sprocket is positioned at a first distance from the first input sprocket. The method further includes, providing a second primary drive assembly including a second drive sprocket and a second input sprocket. The second drive sprocket is positioned at a second distance from the second input sprocket, the second distance being greater than the first distance. The method further includes, placing a locking tool into engagement between the first drive sprocket and the first input sprocket, resisting rotation of the first drive sprocket and the first input sprocket with the locking tool, removing the locking tool from between the first drive sprocket and the first input sprocket, extending the locking tool, placing the extended locking tool into locking engagement between the second drive sprocket and the second input sprocket, and resisting rotation of the second drive sprocket and the second input sprocket with the extended locking tool.

Other aspects of the invention will become apparent by consideration of the detailed description and accompanying drawings.

### BRIEF DESCRIPTION OF THE DRAWINGS

FIG. 1 is a perspective view of a motorcycle upon which the tool and method of the present invention can be used.

FIG. 2 is a partially-exploded, perspective view of an engine-transmission assembly of the motorcycle illustrated in FIG. 1.

FIG. 3 is an exploded view of a crankshaft drive assembly of the engine-transmission assembly of FIG. 2.

FIG. 4 is a cross-section view taken along line 4-4 of FIG. 3.

FIG. 5 is a cross-section view taken along line 5-5 of FIG. 2.

FIG. 6 is a perspective view of a primary locking tool according to one embodiment of the invention.

FIG. 7 is an exploded view of the primary locking tool of FIG. 6.

FIG. 8 is a cross-section view taken along line 8-8 of FIG. 6.

FIG. 9 is the primary locking tool of FIG. 6 illustrating the primary locking tool in a retracted position and engaged with a first primary drive assembly.

FIG. 10 is the primary locking tool of FIG. 6 illustrating the primary locking tool in an extended position and engaged with a second primary drive assembly.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

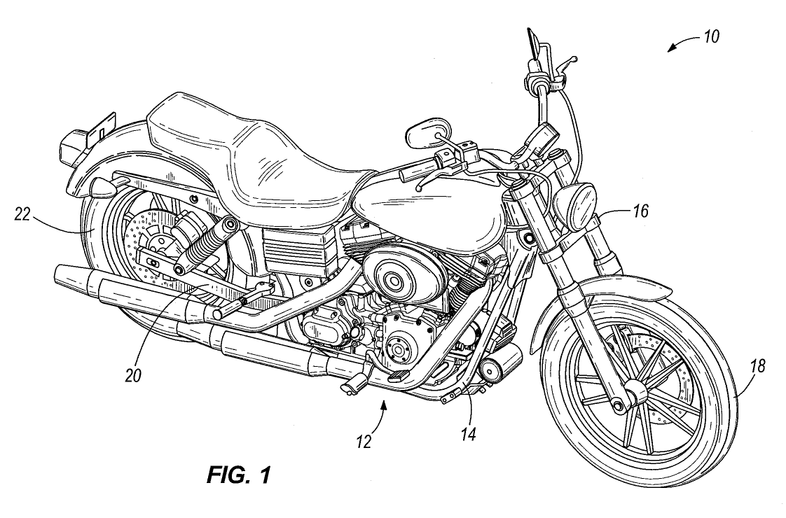

FIG. 1 illustrates a motorcycle 10 including an engine-transmission assembly 12 embodying the invention. The motorcycle 10 includes a frame 14, a steering assembly 16 pivotally coupled to a forward portion of the frame 14, and a front wheel 18 rotatably coupled to the steering assembly 16. A swingarm 20 is pivotally coupled to a rearward portion of the frame 14 and a rear wheel 22 is rotatably coupled to the swingarm 20.

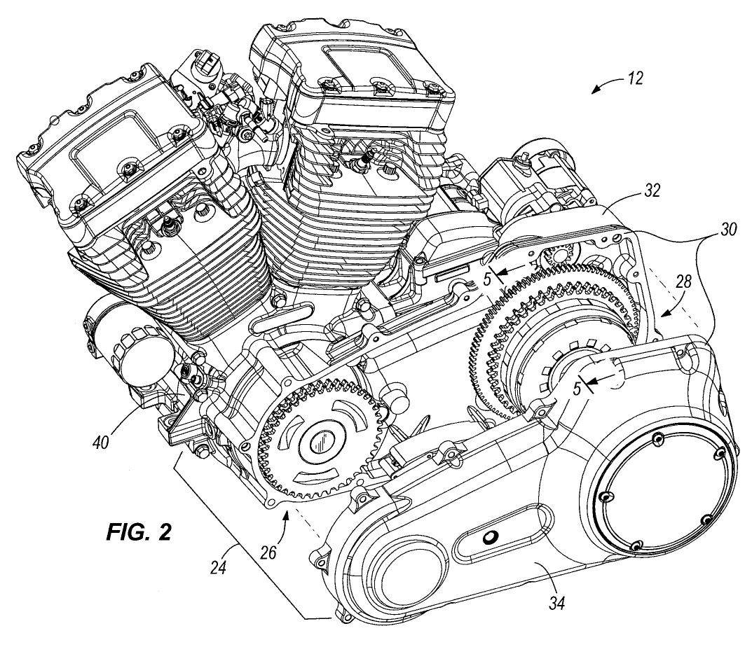

As shown in FIG. 2, the engine-transmission assembly 12 includes a primary drive assembly 24 having a crankshaft drive assembly 26 and a clutch assembly 28. The engine-transmission assembly 12 further includes a primary housing 30, having an inner primary housing 32 and a primary cover 34 coupled to the inner primary housing 32, and a crankcase 40.

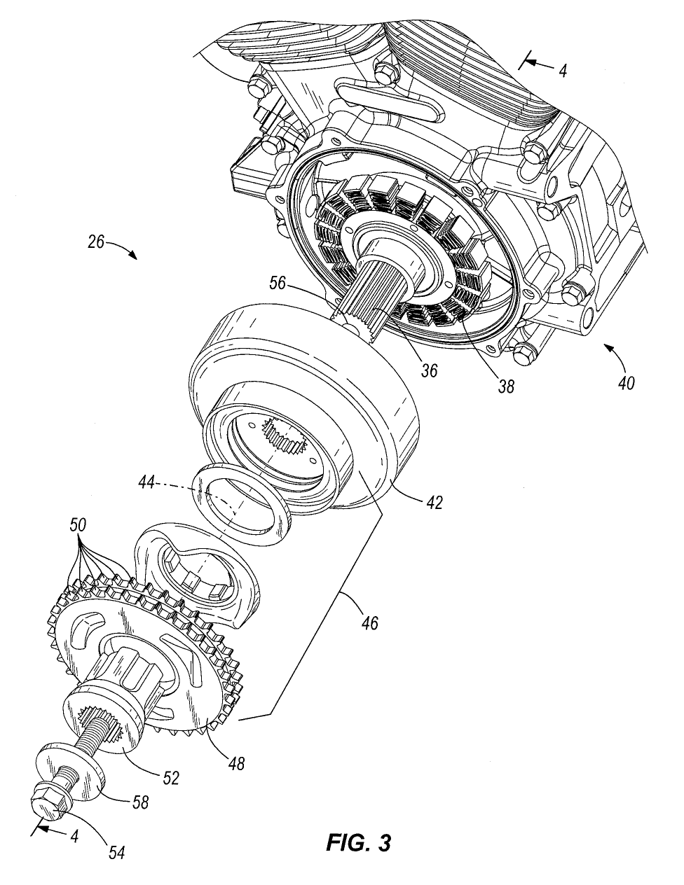

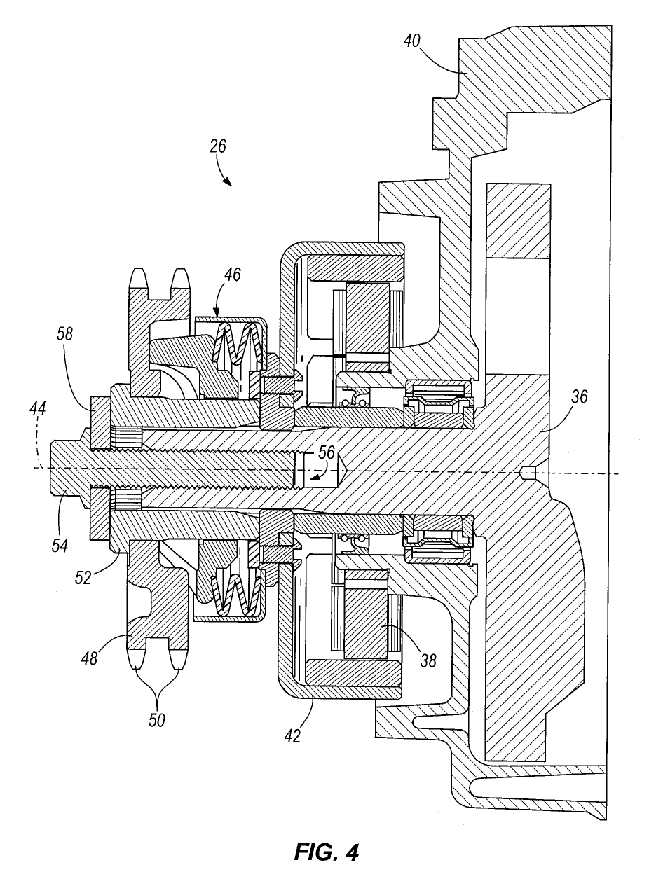

With reference to FIGS. 3 and 4, the crankshaft drive assembly 26 includes a splined crankshaft 36 rotatably coupled to the crankcase 40 and a stator 38 coupled to the crankcase 40. A rotor shell 42 having mating splines is coupled to the crankshaft 36, such that the rotor shell 42 and the crankshaft 36 rotate together about a crankshaft axis 44. A compensator assembly 46 is coupled to the crankshaft 36 adjacent to the rotor shell 42. The compensator assembly 46 is coupled for rotation with the crankshaft 36 and operates to dampen impulse loads between the engine 12 and the rear wheel 22 during motorcycle 10 operation, as described in U.S. Pat. No. 7,143,734, the content of which is incorporated by reference. The crankshaft drive assembly 26 includes a drive sprocket 48 having teeth 50 for engaging a primary chain (not shown). A cylindrical collar 52 is mounted onto the splined crankshaft 36 and includes an external splined portion that engages a mating splined portion on the inside diameter of the compensator 46. A bolt 54 extends through the cylindrical collar 52 and into a threaded aperture 56 in the crankshaft 36. A washer 58 is positioned between the collar 52 and the bolt 54. This bolt 54 retains the crankshaft drive assembly 26 on the crankshaft 36.

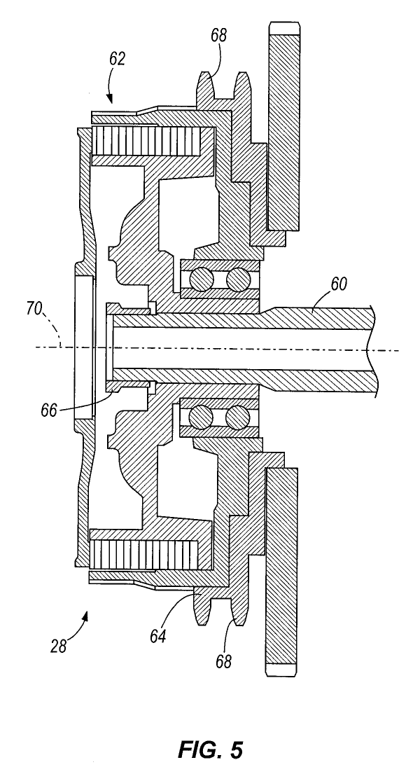

As shown in FIG. 5, the clutch drive assembly 28 includes a main shaft of the transmission 60, a clutch 62, an input sprocket 64, and a nut 66 that is inserted onto the main shaft 60. The input sprocket 64 has teeth 68 for engaging the primary chain during operation. The clutch assembly 28 rotates about a main shaft axis 70. The nut 66 retains the various elements on the main shaft 60.

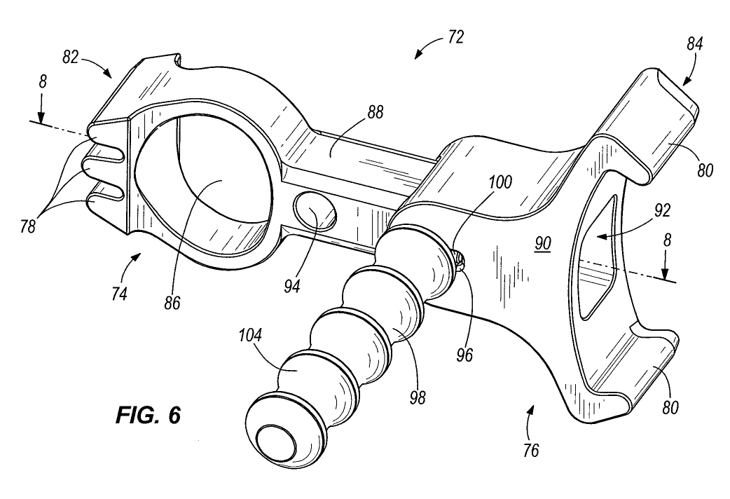

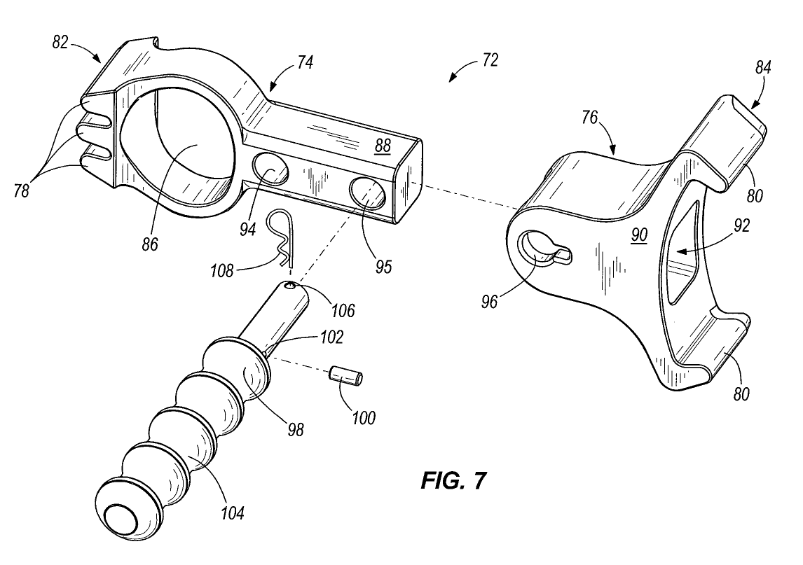

Referring to FIGS. 6 and 7, a universal primary locking tool 72 according to one embodiment of the invention includes first and second side portions 74, 76, respectively. The illustrated first side portion 74 includes three projections 78 extending outward therefrom. The projections 78 define a drive jaw 82. The projections 78 extend out at angles that allow them to mate with the teeth 50 of the sprocket 48 on the crankshaft drive assembly 26. The first side portion 74 has a generally circular aperture 86 therethrough adjacent the projections 78 and an arm 88 that extends away from drive jaw 82. The arm 88 has a generally square cross section and extends generally along the length of the first side portion 74. The arm 88 has two apertures 94, 95 positioned along its length that are generally parallel to and offset from one another.

The illustrated second side portion 76 includes two projections 80 that extend outward therefrom. The projections 80 define an input jaw 84. The second side portion 76 also has a body portion 90 having a keyway aperture 96 that extends therethrough. The body portion 90 also has a receiving aperture 92 that extends generally along the length of the second side portion 76 and has a generally square cross-section. The receiving aperture 92 is generally parallel to the arm 88 of the first side portion 74, such that arm 88 is inserted into the receiving aperture 92. The first and second side portions 74, 76 are moveable with respect to each other, such that the length of the tool is variable.

In some embodiments, clearance exists between the arm 88 and the receiving aperture 92 such that first and second side portions rotate a minor amount with respect to each other about the axis 70 and rotate a minor amount relative to each other in a direction perpendicular to the axis 70.

The tool 72 further includes a handle 98 that slides into the apertures 94, 95, 96 on the first and second side portions 74, 76. The handle 98 retains the first and second side portions 74, 76 from relative movement by being inserted into aligned apertures 94, 96, in a first position, or aligned apertures 95, 96, in a second position. The handle 98 includes an aperture 102 that receives a dowel 100. The handle 98 further includes an aperture 106 for receiving a pin 108. The pin 108 maintains the handle 98 in the aligned apertures, 94, 96 or 95, 96, while it is positioned in aperture 106. Although the illustrated pin 108 is a cotter pin, the pin could be a hitch pin, a shear pin, a split pin or another similar pin or other retaining devices. The dowel 100 acts as a locator by fitting into keyway aperture 96 and inhibiting rotation relative to the handle 98 while in the aligned apertures 94, 96 or 95, 96. The illustrated handle 98 further includes a hand-grip portion 104 that enables an operator to effectively grasp the handle 98.

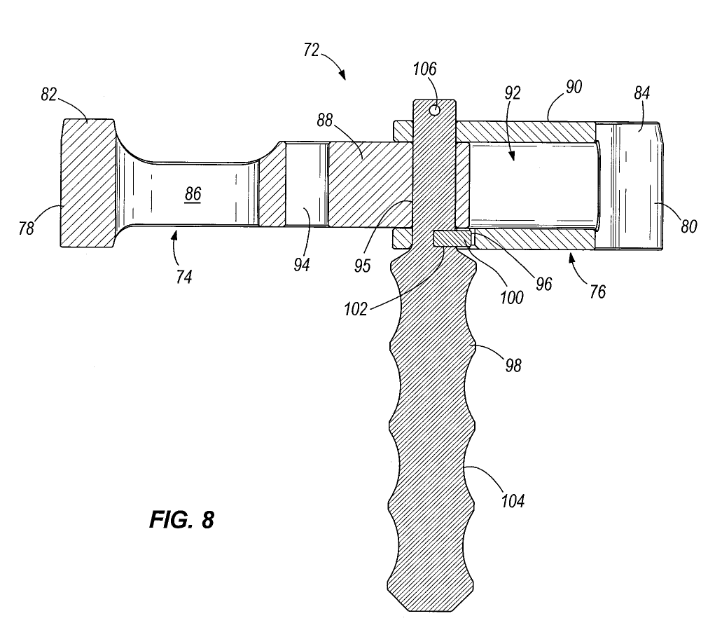

As illustrated in FIG. 8, the dowel 100 is engaged with the keyway 96 to prevent the handle 98 from rotating after the handle 98 is inserted into the keyway 96. Although the pin-receiving aperture 106 is illustrated, the pin 108 is removed for clarity. The handle 98 is inserted into the aperture 95 in the first side portion 74 and the keyway aperture 96 in the second side portion 76. Although the handle 98 is shown with grooves on the hand grip portion 104, other configurations of grooves or handle 98 shapes are possible, such as having a knob on the end of a smooth handle 98, or providing the handle 98 with a textured surface material instead of having grooves on the hand grip portion 104 of the handle 98.

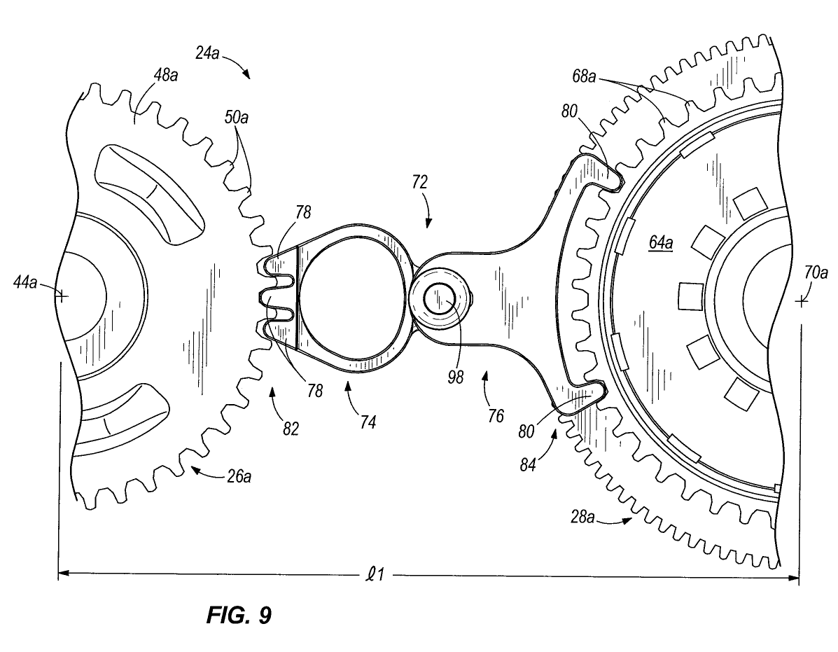

In FIG. 9, the handle 98 is inserted into the apertures 94, 96, respectively to set the tool 72 in a first, retracted position. The tool 72 is inserted into in a first primary drive assembly 24a that defines a first length l1 between the axes 44a, 70a of the drive sprocket 48a and the input sprocket 64a. The tool 72 is held in place between the sprockets 48a, 64a by the respective mating projections 78a, 80a and teeth 50a, 68a of the sprockets 48a, 64a and the input and drive jaws 84, 82, respectively. The tool 72 inhibits rotation of the crankshaft drive assembly 26a and the clutch assembly 28a while in position between the respective assemblies 26a, 28a in the first primary drive assembly 24a.

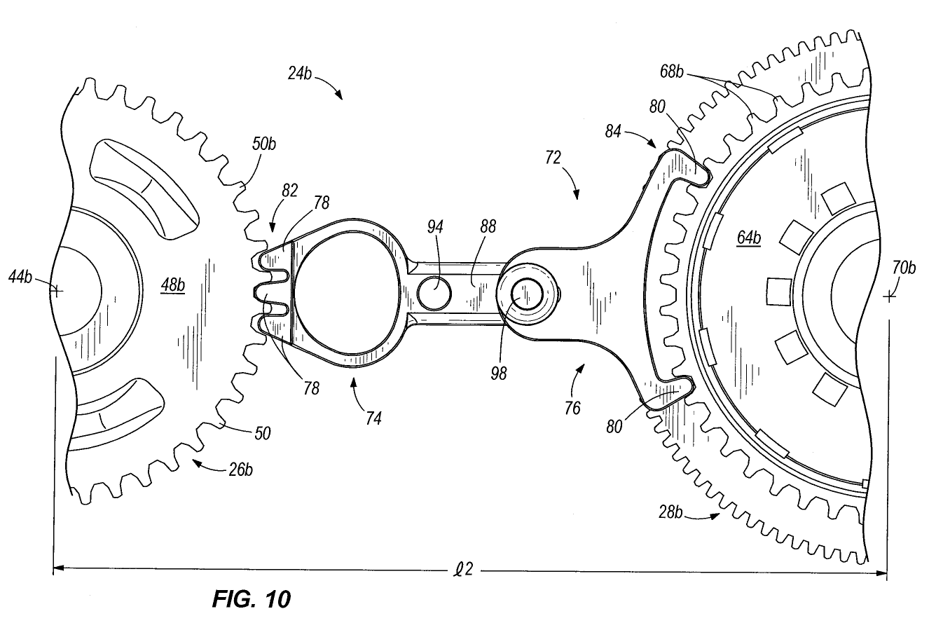

As shown in FIG. 10, the handle 98 is inserted into the apertures 95, 96, to set the tool 72 in a second, extended position. The tool 72 is inserted into a second primary drive assembly 24b that defines a second length l2 between the axes 44b, 70b of the drive sprocket 48b and the input sprocket 64b. The second length l2 is greater than the first length l1. The tool 72 is held in place between the sprockets 48b, 64b by the respective mating projections 78, 80 and teeth 50b, 68b, respectively. The tool 72 inhibits rotation of the crankshaft drive assembly 26b and the clutch assembly 28b while in position between the respective assemblies 26b, 28b in the second primary drive assembly 24b.

Although the drive sprockets 48 and the input sprockets 64 of the first and second primary drive assemblies 24a, 24b respectively, have the same diameters, the tool 72 can be used on drive sprockets 48 and input sprockets 64 of a variety of diameters. For example, the distance between the axes of the sprockets 48, 64 may be the same for two different primary drive assemblies, but the diameters of the sprockets 48, 64 may be different, such that the tool 72 can be adjusted to different lengths to accommodate a variety of sprocket diameters and a variety of primary drive assembly configurations.

In other embodiments, the tool 72 can be adjusted between more than two positions. For example, the tool 72 can be positioned in a retracted position, extended position, or any number of intermediate positions. In some embodiments, the tool 72 is adjusted to any number of positions set at various increments, such as by inserting a pin into any of a number of locking apertures. In other embodiments, the tool 72 is adjusted to any position within a range of positions, such as by sliding the tool to a position and clamping the tool in place at any of the positions.

In operation, the crankshaft drive assembly 26a and the clutch assembly 28a are inserted onto the respective splined shafts 36, 60 in the first primary drive assembly 24a. Before the bolt 54 and nut 66 are tightened, the universal primary locking tool 72 is utilized. The first side portion 74 of the tool 72 is inserted into the second side portion 76. The dowel 100 is inserted into the handle 98, and the handle 98 and dowel 100 assembly are inserted into the keyway aperture 96 on the second side portion 76 and the first aperture 94 on the first side portion 74. The dowel 100 inhibits rotation of the handle 98 after it is inserted into the apertures 94, and 96. The pin 108 is inserted into the pin-receiving aperture 106 on the handle 98 to hold the handle 98 in the apertures 94, 96 and maintain the tool 72 at the retracted position.

Next, the tool 72 is inserted between the crankshaft drive assembly 26a and the clutch assembly 28a of the first primary drive assembly 24a. The projections 78, 80 on the tool 72 mate with teeth 50, 68 on both the sprockets 48a, 64a. The bolt 54 and nut 66 are then tightened by an operator while the tool 72 inhibits rotation of the crankshaft drive assembly 26a and the clutch assembly 28a. Once tightened, the tool 72 is removed from the first primary drive assembly 24a.

Then, the pin 108 is removed from the pin-receiving aperture 106 on the handle 98 to allow the handle 98 and dowel 100 assembly to be removed from the apertures 94, 96 in the first and second portions 74, 76, respectively. The first side portion 74 is slid away from the second side portion 76 and the handle 98 and dowel 100 assembly is inserted into aperture 95 on the first side portion 74 and the keyway aperture 96 on the second side portion 76. The pin 108 is inserted into the pin-receiving aperture 106 on the handle 98 to retain the handle 98 within the apertures 94, 96, and maintain the tool 72 in the extended position.

The tool 72 is then inserted into the second primary drive assembly 24b between the crankshaft drive assembly 26b and the clutch assembly 28b. The tool 72 engages the teeth 52b, 58b of the respective sprockets 48b, 64b with the input jaw 84 and the drive jaw 82. The bolt 54 and nut 66 are then tightened by an operator on the second primary drive assembly 24b. Once tightened, the tool 72 is then removed from the second primary drive assembly 24b.

Various features and advantages of the invention are set forth in the following claims.

What is claimed is:

1. A method of assembling primary drive assembies of engine-transmission assemblies, the method comprising:
providing a first primary drive assembly including a first drive sprocket and a first input sprocket, wherein the first drive sprocket is positioned at a first distance from the first input sprocket;
providing a second primary drive assembly including a second drive sprocket and a second input sprocket, wherein the second drive sprocket is positioned at a second distance from the second input sprocket, the second distance being greater than the first distance;
placing a locking tool into engagement between the first drive sprocket and the first input sprocket;
resisting rotation of the first drive sprocket and the first input sprocket with the locking tool;
removing the locking tool from between the first drive sprocket and the first input sprocket;
extending the locking tool;
placing the extended locking tool into locking engagement between the second drive sprocket and the second input sprocket; and
resisting rotation of the second drive sprocket and the second input sprocket with the extended locking tool.

2. The method of claim 1, further comprising removing a handle from a first aperture in at least one of a first and second portion of the locking tool.

3. The method of claim 2, further comprising inserting the handle into a second aperture in at least one of the first and second portions of the tool.

4. The method of claim 2, further comprising resisting rotation of the handle relative to the first and second portions by inserting a dowel of the handle into a recess of one of the first and second portions.

5. The method of claim 2, further comprising retaining the handle in the first aperture in one of the first and second portions by inserting a pin through an aperture in the handle.

6. The method of claim 1, further comprising sliding an arm of a first portion of the tool from an aperture of a second portion of the tool.

7. A primary locking tool for use with first and second primary drive assemblies, the first primary drive assembly including a first drive sprocket and a first input sprocket a first distance from the first drive sprocket, the second primary drive assembly including a second drive sprocket and a second input sprocket a second distance from the second drive sprocket, the second distance being greater than the first distance, the primary locking tool comprising:
a first side portion including a drive jaw configured to engage the first and second drive sprockets;
a second side portion including an input jaw configured to engage the first and second input sprockets, the first and second side portions coupled together and moveable relation to each other between a retracted position, operable to engage and resist rotation of the first drive sprocket and the first input sprocket, and an extended position, operable to engage and resist rotation of the second drive sprocket and the second input sprocket.

8. The primary locking tool of claim 7, wherein the first and second side portions are coupled together in a telescoping engagement.

9. The primary locking tool of claim 7, wherein the first side portion is configured to slidingly receive the second portion.

10. The primary locking tool of claim 7, further including a handle extending through the first side portion and the second side portion in the retracted position to resist extension of the first side portion with respect to the second side portion.

11. The primary locking tool of claim 10, wherein the handle is removable to allow the first and second side portions to move to the extended position, and wherein the handle is extendable through the first and second side portions to maintain the first and second side portions in the extended position.

12. The primary locking tool of claim 10, wherein at least one of the first side portion and the second side portion includes one of a projection and a recess, and wherein the handle includes a the other one of the projection and recess, the recess configured to receive the projection to resist rotation of the handle relative to the first and second side portions.

13. The primary locking tool of claim 10, further comprising a pin extending through an aperture of the handle to maintain the handle through the first and second side portions.

14. A primary locking tool for use with first and second primary drive assemblies, the first primary drive assembly including a first drive sprocket and a first input sprocket a first distance from the first drive sprocket, the second primary drive assembly including a second drive sprocket and a second input sprocket a second distance from the second drive sprocket, the second distance being greater than the first distance, the primary locking tool comprising:
a first side portion including a drive jaw configured to engage the first and second drive sprockets;
a second side portion including an input jaw configured to engage the first and second input sprockets, the second side portion coupled to the first side portion for adjustment between at least first and second positions, the first and second side portions disposed a further distance apart from each other in the second position than the first position;
a locking mechanism engageable to lock the second side portion in one of the first and second positions, and disengageable to allow adjustment of the second side portion between the first and second positions.

15. The primary locking tool of claim 14, wherein the first and second side portions are coupled together in a telescoping engagement.

16. The primary locking tool of claim 14, wherein the first side portion is configured to slidingly receive the second side portion.

17. The primary locking tool of claim 14, wherein the locking mechanism includes a handle extending through the first and second side portions when the second side portion is in the first position to resist movement of the second side portion with respect to the first side portion.

18. The primary locking tool of claim 17, wherein the handle is removable from the first and second side portions to allow the second side portion to move to the second position, and wherein the handle is extendable through the first and second side portions to maintain the second side portion in the second position.

19. The primary locking tool of claim 17, wherein the handle includes a projection that is configured to be received with a mating recess of at least one of the first and second side portions to resist rotation of the handle relative to the first and second side portions.

20. The primary locking tool of claim 17, further comprising a pin extending through an aperture of the handle to maintain the handle through the first and second side portions.
